(19) United States
(12) Patent Application Publication
(10) Pub. No.: US 2025/0198382 A1
(43) Pub. Date: Jun. 19, 2025

(54) ELECTRICITY GENERATION BY WIND POWER

(71) Applicant: Norbert MEIER, Sengenthal (DE)

(72) Inventor: Norbert MEIER, Sengenthal (DE)

(21) Appl. No.: 18/978,515

(22) Filed: Dec. 12, 2024

(30) Foreign Application Priority Data
Dec. 14, 2023 (DE) 10 2023 135 121.4

(51) Int. Cl. F03D 9/25; F03D 3/00; F03D 15/20; F03G 3/06

(52) U.S. Cl. CPC F03D 9/25; F03D 3/005; F03D 15/20; F03G 3/06; F05B 2240/211; F05B 2240/311

(57) ABSTRACT

A wind-powered apparatus for generating electricity as well as to a method for generating electricity by wind power is provided. In order to provide a technology for wind-powered generation of electricity with improved efficiency, a wind-powered apparatus for generating electricity is proposed. The apparatus may have a vertical rotor, a first drive shaft drivable by the vertical rotor, a second drive shaft, an electric generator drivable by the second drive shaft, and a movable lever assembly. The first drive shaft may be operatively connected to the lever assembly for driving the assembly. The lever assembly is operatively connected to the second drive shaft for driving the shaft. The lever assembly may have a lever linkage configured to be able to perform a reciprocating motion between a first reciprocating position and a second reciprocating position without losing the operative connection to the first drive shaft and to the second drive shaft.

### FIELD

The invention relates to a wind-powered apparatus for generating electricity as well as to a method for generating electricity by wind power.

### BACKGROUND

Wind generators for private households and other consumers with low power consumption are becoming more and more popular. However, the efficiency of these installations is often poor.

It is an object of the present invention to provide a technology for wind-powered generation of electricity with improved efficiency.

The object is achieved by means of an apparatus according to claim 1 and a method according to claim 20, respectively. Advantageous embodiments of the invention are provided in the dependent claims or will become apparent from the following description and/or the accompanying figures. The advantages and embodiments explained below in the context of the apparatus according to the invention also apply correspondingly to the method according to the invention and vice versa.

### SUMMARY

The wind-powered apparatus for generating electricity according to the invention comprises a vertical rotor, a first drive shaft drivable by the vertical rotor, a second drive shaft, an electric generator drivable by the second drive shaft, and a movable lever assembly, wherein the first drive shaft is operatively connected to the lever assembly for driving said assembly, and wherein the lever assembly is operatively connected to the second drive shaft for driving said shaft. Thereby, the lever assembly comprises lever linkage configured to be able to perform a reciprocating motion between a first reciprocating position and a second reciprocating position without losing the operative connection to the first drive shaft and to the second drive shaft.

In the method according to the invention for generating electricity by wind power, a vertical rotor drives a first drive shaft, a movable lever assembly operatively connected to the first drive shaft is driven by the first drive shaft, the lever assembly drives the second drive shaft, for this purpose the lever assembly is operatively connected to the second drive shaft, and an electric generator operatively connected to the second drive shaft is driven by the second drive shaft. Thereby, the lever assembly comprises lever linkage configured to perform a reciprocating motion between a first reciprocating position and a second reciprocating position without losing the operative connection to the first drive shaft and to the second drive shaft.

One basic idea of the invention is the use of a force converter that changes the magnitude of the force between the vertical rotor and the rotary generator, whereby the force converter is embodied as a lever assembly. In this manner, even at comparatively small torques of the vertical rotor, comparatively large torques may be generated at the second drive shaft for driving the electric generator. This allows operating generators in a way that is useful for generating electricity even at low wind speeds, if vertical wind turbines are used.

Here, the lever assembly does not serve as an arbitrarily interchangeable connection or coupling means between vertical rotor and generator. Rather, it defines a fundamental principle of the invention. The advantage according to the invention is most pronounced, when the ratio of the lengths of the lever arms (effort arm, load arm) is suitably selected and the length of the effective lever arm formed by the lever assembly is utilized to its maximal possible extent. In preferred embodiments, the effect of the lever assembly is optimized by additional weights and other means. As a result, a machine for power conversion with a simple design is provided that is inexpensive to manufacture compared to other assemblies and is therefore particularly suitable for wind generators for private use. Here, above a certain wind speed, the generator is steadily and continuously driven by the vertical rotor. Such an operation is already possible at low wind speeds at or above about 5 km/h, at a first drive shaft speed of about 20 rpm. Designed as a low-speed rotor, the vertical rotor produces comparatively little noise, which makes the invention particularly suitable for deployment in residential areas.

According to an embodiment of the invention, the motion of the lever assembly is a reciprocating motion (oscillating motion) about a lever pivot point.

According to an embodiment of the invention, in order to utilize the lever assembly, the form of motion is changed twice, namely first from a rotation of the first drive shaft driven by the vertical rotor into a motion of the lever assembly, and secondly, from the motion of the lever assembly into a rotational motion of the second drive shaft that drives the generator.

According to an embodiment of the invention, the lever linkage is designed as a type of inverse pendulum, such that it may move in two directions and allows the oscillating motion of the lever assembly about the lever pivot point.

Thereby, the lever linkage is preferably configured to include a lever arm, in particular for forming a double-ended lever. The effort arm is operatively connected to the first drive shaft, and the load arm is operatively connected to the second drive shaft. The lever arm is preferably installed in a fixed bearing. This bearing forms the pivot point of the lever arm. The ratio of the lengths of the effort arm and the load arm is preferably at least 3:1. Particularly advantageous are length ratios of at least 4:1.

In particularly preferred embodiments of the invention, the lever assembly includes one or more additional weights connected to the lever linkage. These additional weights can assist with the reciprocating motion of the lever linkage.

According to an embodiment of the invention, additional weights are attached to one or more positions on the lever arm. This way, the mass distribution within the lever arm can be manipulated for optimizing the reciprocating motion. Additional weights may be provided at at least one of the free end of the load arm and the free end of the effort arm, in other words, at both ends of the lever arm. Additionally or alternatively, additional weights may also be provided at at least one of the load arm and the effort arm at specific distances from the pivot point. It is also possible, that additional weights are attached to a support arm fixedly connected to the lever arm, which supports the additional weight at a distance from the lever arm as a sort of boom.

Alternatively or additionally, however, for optimizing the reciprocating motion, additional weights may be attached to at least one of the lever arm and the support arm by means of connecting members, and/or additional weights are attached as pendulum weights to at least one gravity pendulum, which is connected to the lever arm, in particular to the free end of the load arm or proximate to this free end, or to a support arm. In this manner, a motion supporting the reciprocating motion of the lever linkage or a motion superimposing the reciprocating motion that supports the reciprocating motion at least temporarily arises. In particular, gravitational and centrifugal forces may generate a momentum supporting the motion of the lever assembly that contributes to maintaining a sustained operation of the generator at the desired or at least a sufficient speed even at changing wind speeds or wind directions.

According to an embodiment of the invention, the lever assembly includes at least one additional moving member connected to the lever linkage by means of a connecting member, in particular spaced apart from the pivot point of the lever arm. The at least one additional moving member is preferably configured such that it performs a periodic linear motion when the lever assembly moves. Thereby, the operative connection between the lever assembly and the second drive shaft is established using this at least one additional moving member.

An embodiment of the invention has been shown to be particularly advantageous, where the at least one additional moving member is embodied as a weight slidable on a track, in particular on an inclined plane. Advantageously, the weight is provided with rollers or other suitable means to minimize the friction arising during the motion. By employing an additional force converter in the form of an inclined plane, the efficiency of the wind generator is improved once more. Preferably, two opposing moving members are provided that are movable corresponding to the direction of the reciprocating motion, such that the weights are each moved depending on the reciprocating position along the track. In particular, the embodiment is such that during a motion of the reciprocating linkage into the first reciprocating position, one of the weights is pulled up the inclined plane while the other weight moves down the inclined plane; during an opposite motion of the reciprocating linkage into the second reciprocating position, the weights move in exactly the opposite directions.

According to other embodiments of the invention, the operative connection between the lever assembly on the one hand and the second drive shaft on the other hand is effected by use or by means of alternative or additional lever assemblies and/or force converters. This is intended to achieve a particularly efficient operation of the generator. In particular, this is intended to generate particularly large torques for driving the electric generator even at low wind speed.

According to an embodiment of the invention, the operative connection between the first drive shaft and the lever assembly and/or the operative connection between the lever assembly and the second drive shaft is established using a linkage that acts as a transmission gearing including a change of the form of motion.

This linkage is preferably configured as a slotted link mechanism, in a particularly simple variant as a Scotch yoke with a sliding guide. A slotted link mechanism is employed that converts the rotational motion of a drive shaft into a linear motion of a reciprocating slider or vice versa. A pin of the rotating component engages with a slot of a slide that is directly connected to the slider. Other suitable linkages may be used.

When using the linkage for the operative connection between the first drive shaft and the lever assembly, the rotational motion of the first drive shaft is converted into a linear motion of the slider. The lever assembly is then acted upon via this slider and put into a reciprocating motion. According to a preferred embodiment of the invention, the operative connection between the first drive shaft and the lever assembly is established by means of a connecting member engaging with the lever assembly. The slider is preferably connected to the lever assembly, in particular the effort arm of the lever arm of the lever linkage, via an elastic and/or resilient connecting member, such as an elastic strap, rope, or the like. The elasticity of the connection of the lever assembly to the first drive shaft ensures on one hand, that a retroactive action of the motion of the lever assembly onto the rotation of the rotor is impossible. On the other hand, it ensures that the lever assembly is able to continue moving, even if it is not driven.

When using the linkage for the operative connection between the lever assembly and the second drive shaft, the motion of the lever assembly is directly or indirectly converted into a rotation.

Preferably, a linear motion of the at least one moving member caused by the reciprocating motion of the lever assembly is converted into a rotational motion of the second drive shaft. This rotational motion may directly be the rotational motion of the second drive shaft. Alternatively, additional gearing may be disposed between the linkage and the second drive shaft that serves as a transmission gearing in the sense of a power amplifier, for example a belt drive, which transmits the torque over two differently dimensioned pulleys and a belt to the second drive shaft.

In has been shown to be particularly advantageous, when a vertical rotor is utilized for driving the wind generator, that is, a rotor with a vertical axis of rotation. Preferably a rotor is used with a rotational motion independent of the direction of the wind, because in this case no wind direction tracking is needed.

According to a preferred embodiment of the invention, the vertical rotor includes a plurality of rotor blades that are angularly evenly distributed around the vertical rotor axis, wherein the rotor blades are configured and attached to a rotary linkage of the rotor by means of preferably elastically deformable limiting members limiting the pivoting range of the rotor blades, such that they individually and autonomously move into or out of the wind. The number of blades is at least three; preferably five or more blades are used.

According to a preferred embodiment of the invention, the rotor blades are configured as flexible blades autonomously pivotable about vertical pivot axes. Preferably, the blades are configured as sails and are made of canvas or another suitable material. The sails and their attachments to the rotor frame are preferably configured to automatically adjust to the wind direction, that is, the sails align themselves with the air current and drive the rotor. If sails are employed, these may be lowered by simple means when an upper wind speed limit is exceeded.

Additionally, according to preferred embodiments of the invention, in particular in order to avoid start-up difficulties at low wind power, suitable coupling means are also provided that serve to disconnect the operative connection between the rotor and the drive shaft or lever assembly or to establish said operative connection, depending on the power provided by the wind power or the achievable speeds.

Suitable adjustment means, in particular gears, couplings and/or torque or speed control means, ensure that an optimal operative speed of the second drive shaft is reached.

Not shown in the figures are support, bearing, holding and carrying structures for individual components of the apparatus. Such structures, as well as suitable coupling and adjustment means, are known to one skilled in the art, so that these do not need to be described in further detail herein.

### DESCRIPTION OF THE FIGURES

An example embodiment of the invention will be explained below in more detail with reference to the drawings. In these:

FIG. 1 illustrates a schematic representation of an apparatus according to the invention in the resting position,

FIG. 2 illustrates a schematic representation of the apparatus according to the invention in a first reciprocating position,

FIG. 3 illustrates an embodiment with alternatively arranged additional weights,

FIG. 4 illustrates an embodiment with alternatively arranged additional weights,

FIG. 5 illustrates an embodiment with alternatively arranged additional weights,

FIG. 6 illustrates a perspective view of the vertical rotor.

### DETAILED DESCRIPTION

None of the figures are to scale, they illustrate the invention merely schematically and only with its essential components. Therein, identical reference signs correspond to elements with the same or comparable function.

A wind-powered apparatus 1 for generating electricity comprises a vertical rotor 2, a first drive shaft 3 drivable by the vertical rotor 2, a second drive shaft 4, an electric generator 5 drivable by the second drive shaft 4, and a movable lever assembly 6, wherein the first drive shaft 3 is operatively connected to the lever assembly 6 for driving said assembly, and wherein the lever assembly 6 is operatively connected to the second drive shaft 4 for driving said shaft. Thereby, the rotational motion of the first drive shaft 3 driven by the vertical rotor 2 is converted into a reciprocating motion of the lever assembly 6, and the reciprocating motion of the lever assembly 6 is converted into a rotational motion of the second drive shaft 4 that drives the generator 5.

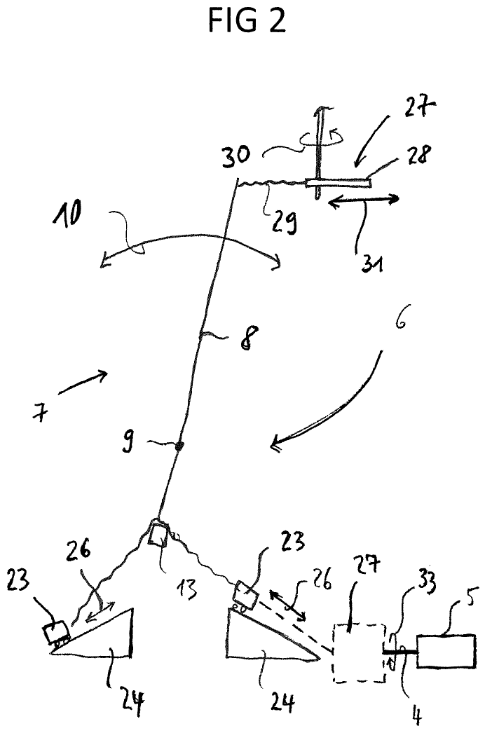

The lever assembly 6 comprises lever linkage 7 that can perform a reciprocating motion between a first reciprocating position and a second reciprocating position without losing the operative connection to the first drive shaft 3 and to the second drive shaft 4. The state of the first reciprocating position is shown in FIG. 2. The lever linkage 7 is designed as a type of inverse pendulum, such that it may move in two directions and allows the oscillating reciprocating motion 10 of the lever assembly 6 about a lever pivot point 9. Herein, the lever linkage 7 includes a lever arm 8 for forming a double-ended lever that forms an inverse pendulum. The effort arm 11 of the lever arm 8 is operatively connected to the first drive shaft 3, and the load arm 12 of the lever arm 8 is operatively connected to the second drive shaft 4. The lever arm 8 is mounted in a fixed bearing forming the pivot point 9 of the lever arm 8.

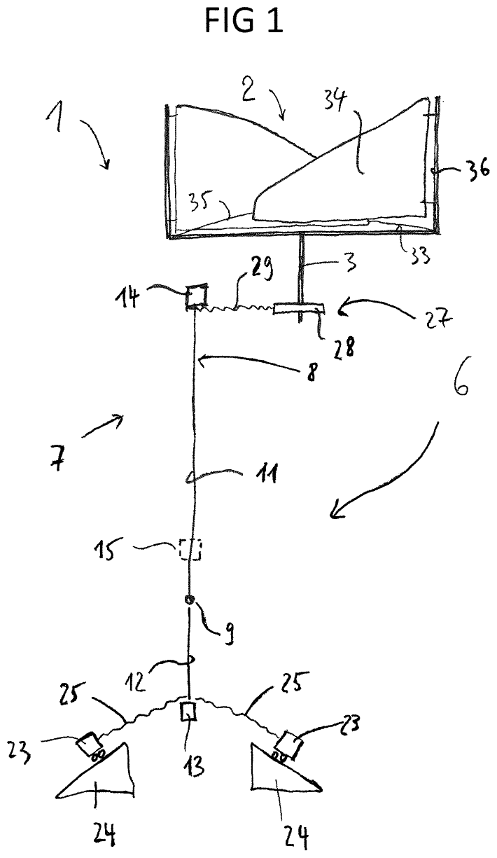

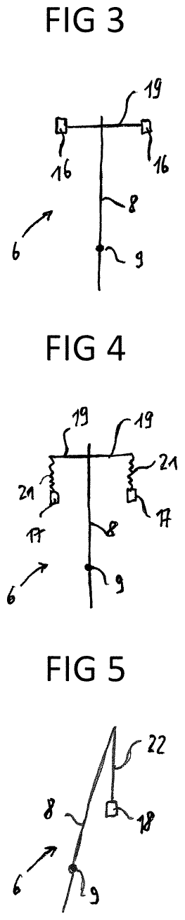

An additional weight 13 attached to the free end of the load arm 12 is illustrated in FIG. 1. In FIG. 1, additional weights 14, 15 are merely indicated schematically, which are attached to the free end of the effort arm 11 and at a defined distance from the pivot point 9 to the lever arm 8, respectively. FIG. 3 shows additional weights 16 arranged in pairs that are attached to the support arms 19, which are fixedly connected to the lever arm 8 and support the additional weights 16 at a distance from the lever arm 8 as a sort of booms. FIG. 4 depicts additional weights 17, which are attached to the support arms 19 by means of spring members 21. FIG. 5 shows an additional weight 18 attached as a pendulum weight to a gravity pendulum 22, whereby the gravity pendulum 22 is connected to the free end of the effort arm 11.

The lever assembly 6 includes two additional moving members connected to the lever linkage 7 in the form of weights 23 provided with rollers and movable on an inclined plane 24. These weights 23 are connected to the lever arm 8 at a distance from the pivot point 9 of the lever arm 8, namely at the free end of the load arm 12, by means of pull ropes 25. When the lever assembly 6 moves, the opposing weights 23 movable corresponding to the direction of the reciprocating motion 10 perform a periodic linear motion 26, by each moving along the inclined plane 24 depending on the reciprocating position. This is performed such that during a motion of the lever linkage 7 into the first reciprocating position, one of the weights 23 is pulled up the inclined plane 24 while the other weight 23 moves down the second inclined plane 24, as shown in FIG. 2; during the opposite motion of the lever linkage 7 into the second reciprocating position, the weights 23 move in exactly the opposite directions. Instead of the pull ropes 25, rigid connecting members may also be used between the lever arm 8 and the weights 23, provided that these are appropriately hinged at the connection points. If—in a modification of FIG. 3—an additional weight 16 attached to a support arm is only provided on one side of the lever arm 8, and if a support arm 19 with such an asymmetric additional weight 16 is in particular attached between the pivot point 9 and the free end of the effort arm 11, then the additional moving members, here in the form of movable weights 23, may have different weights.

Alternative to weights 23 that are movable on inclined planes 24, these weights may also be moved on seesaws (not shown), which act as additional lever assemblies. By using such seesaws, large torques for driving the electric generator 5 may be generated as well, in particular in combination with additional lever assemblies and/or force converters driven by the seesaw.

Alternative to weights 23 movable on inclined planes 24 additional moving members may be provided, such that, on the free end of the load arm 12, two opposing support arms 19 as some sort of booms are provided, at their free ends weights are attached, said weights act upon additional lever assemblies when the lever arm 8 reciprocates, in order to generate large torques for driving the electric generator (not shown).

In the illustrated example, the operative connection between the first drive shaft 3 and the lever assembly 6 is established by using a linkage 27 that is configured as a slotted link, namely as a Scotch yoke with a sliding guide. A slotted link mechanism is employed that converts the rotational motion 30 of the first drive shaft 3 into a linear motion 31 of a reciprocating slider 28. A pin driven by the first drive shaft thereby engages with a slot of a slide of the linkage 27, and said slide is connected with the slider 28 (not illustrated in detail). The lever assembly 6 is then acted upon via this slider 28, because the slider 28 is connected to the free end of the effort arm 11 via a preferably elastically deformable pull rope 29. Every time the slider 28 moves away from the lever linkage 7, the lever arm 8 is entrained by the pull rope 29 and thereby put into an oscillating reciprocating motion 10.

Instead of such a one-sided pulling force of the lever linkage 7, a pulling force may be provided that acts upon the lever linkage 7 from two opposing sides (not illustrated).

Furthermore, the operative connection between the lever assembly 6 and the second drive shaft 4 is established by using a linkage 27. Thereby, the linear motion 26 of the two weights 23 movable on the inclined planes 24 induced by the reciprocating motion of the lever assembly 6 is converted into a rotational motion 30 of the second drive shaft 4. FIG. 2 merely indicates this second linkage 27 schematically. This may be embodied by interconnecting a belt drive with two differently dimensioned pulleys between the linkage 27 and the second drive shaft 4 (not illustrated). In the example outlined herein, only one electric generator 5 is provided on the active side of the lever arm 8. In other embodiments, two electric generators may be operated simultaneously by providing a second drive shaft 4 for each movable weight 23.

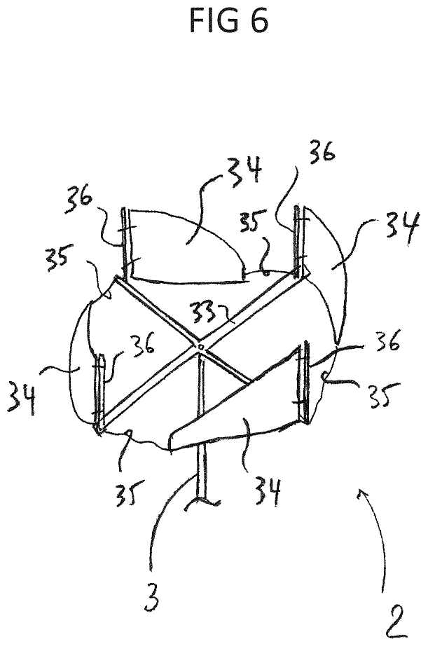

The vertical rotor 2 driving the first drive shaft 3 includes a plurality of rotor blades that are angularly evenly distributed around the vertical rotor axis, in the illustrated example four blades, that are embodied as sails 34 made of canvas or another suitable material. The sails 34 have a substantially triangular shape, such that also those sails are streamed against that are arranged behind in the direction of flow at any given time. The sails 34 may pivot autonomously about vertical pivot axes by being attached to corresponding masts 36 in a flexible manner, herein by way of example with rubber straps. At their sides facing away from the mast, the sails 34 are attached to outer edges of a rotary linkage 33 of the rotor 2 by means of elastically deformable limiting members, for example in the form of additional rubber straps 35 or other suitable means. In this manner, the sails 34 may individually and autonomously move into or out of the wind, whereby the rubber straps 35 limit the pivoting ranges of the sails 34, as shown in FIG. 6.

All the features shown in the description, the following claims, and the drawings may be essential to the invention both individually and in any combination with one another. These features or combinations of features may each constitute an independent invention, the claim of which is expressly reserved.

When specifying a combination of features defining an invention, individual features from the description of an embodiment example do not necessarily have to be combined with one or more or all other features specified in the description of this embodiment example; in this respect, each subcombination of features of one or more example embodiments is expressly disclosed.

In addition, the material features of the apparatus may be restated for use as method features and method features can be restated for use as material features of the apparatus. Features restated in this manner are disclosed implicitly.

### LIST OF REFERENCE NUMERALS

1 Electricity generating apparatus
2 Vertical rotor
3 First drive shaft
4 Second drive shaft
5 Electric generator
6 Lever assembly
7 Lever linkage
8 Lever arm
9 Pivot point
10 Reciprocating motion
11 Effort arm
12 Load arm
13 Additional weight
14 Additional weight
15 Additional weight
16 Additional weight
17 Additional weight
18 Additional weight
19 Support arm
20 (free)
21 Spring member
22 Gravity pendulum
23 Moving member, weight
24 Inclined plane
25 Pull rope
26 Linear motion of a moving member
27 Linkage
28 Slider
29 Pull rope
30 Rotational motion of the first drive shaft
31 Linear motion of the slider
32 Rotary linkage
33 Rotational motion of the second drive shaft
34 Sail
35 Rubber strap
36 Mast

What is claimed is:

1. A wind-powered apparatus for generating electricity, comprising:
a vertical rotor,
a first drive shaft drivable by the vertical rotor,
a second drive shaft,
an electric generator drivable by the second drive shaft, and
a movable lever assembly,
wherein the first drive shaft is operatively connected to the lever assembly for driving said assembly, and
wherein the lever assembly is operatively connected to the second drive shaft for driving said shaft,
and wherein the lever assembly comprises lever linkage configured to be able to perform a reciprocating motion between a first reciprocating position and a second reciprocating position without losing the operative connection to the first drive shaft and to the second drive shaft.

2. The apparatus according to claim 1, wherein the lever linkage comprises a lever arm, the effort arm of which is operatively connected to the first drive shaft and the load arm is operatively connected to the second drive shaft.

3. The apparatus according to claim 2, wherein the lever arm is embodied as a type of inverse pendulum.

4. The apparatus according to claim 1, wherein the lever assembly comprises an additional weight connected to the lever linkage.

5. The apparatus according to claim 4, wherein the additional weight is attached to one or more positions of the lever arm.

6. The apparatus according to claim 5, wherein the additional weight is attached to one or more of:
the free end of the effort arm,
the free end of the load arm,
a support arm fixedly connected to the lever arm, said support arm supporting the additional weight at a distance from the lever arm as a sort of boom.

7. The apparatus according to claim 4, wherein the additional weight is attached to at least one of the lever arm and the support arm by means of an elastically deformable connecting member.

8. The apparatus according to claim 4, wherein the additional weight is attached to a gravity pendulum as a pendulum weight, said gravity pendulum being connected to the lever arm.

9. The apparatus according to claim 8, wherein said gravity pendulum being connected to the lever arm at the free end of the load arm or proximate to this free end.

10. The apparatus according to claim 8, wherein said gravity pendulum being connected to the lever arm at the support arm.

11. The apparatus according to claim 1, wherein the lever assembly comprises at least one additional moving member connected to the lever linkage by means of a connecting member, wherein the at least one additional moving member is configured such that it performs a periodic linear motion when the lever assembly moves, and wherein the operative connection between the lever assembly and the second drive shaft is established using said at least one moving member.

12. The apparatus according to claim 1, wherein the operative connection between the first drive shaft and the lever assembly is established by means of a linkage acting as transmission gearing including a change of the form of motion.

13. The apparatus according to claim 1, wherein the operative connection between the lever assembly and the second drive shaft is established by means of a linkage acting as transmission gearing including a change of the form of motion.

14. The apparatus according to claim 1, wherein the operative connection between the first drive shaft and the lever assembly is established by means of a connecting member that engages with the lever assembly.

15. The apparatus according to claim 14, wherein the connecting member is preferably elastically deformable.

16. The apparatus according to claim 1, wherein the vertical rotor comprises a plurality of rotor blades angularly evenly distributed around the rotor axis, wherein the rotor blades are configured and attached to a rotary linkage of the rotor by means of limiting members limiting the pivoting range of the rotor blades, such that they individually and autonomously move into or out of the wind.

17. The apparatus according to claim 16, wherein the limiting members are elastically deformable.

18. The apparatus according to claim 16, wherein the rotor blades are configured as flexible blades autonomously pivotable about vertical pivot axes.

19. The apparatus according to claim 18, wherein the rotor blades are configured as sails.

20. A method for generating electricity by wind power, comprising
a vertical rotor driving a first drive shaft,
a movable lever assembly operatively connected to the first drive shaft being driven by the first drive shaft,
the lever assembly driving the second drive shaft, for which purpose the lever assembly is operatively connected to the second drive shaft,
an electric generator operatively connected to the second drive shaft being driven by the second drive shaft,
wherein the lever assembly comprises lever linkage configured to perform a reciprocating motion between a first reciprocating position and a second reciprocating position without losing the operative connection to the first drive shaft and to the second drive shaft.
